(19) United States
(12) Patent Application Publication
(10) Pub. No.: US 2015/0256013 A1
(43) Pub. Date: Sep. 10, 2015

(54) PORTABLE POWER SUPPLY

(71) Applicant: Shenzhen Hello Tech Energy Co., Ltd., Shenzhen (CN)

(72) Inventor: Meichan Wen, Shenzhen (CN)

(73) Assignee: Shenzhen Hello Tech Energy Co., Ltd., Shenzhen (CN)

(21) Appl. No.: 14/281,180

(22) Filed: May 19, 2014

(30) Foreign Application Priority Data
Mar. 4, 2014 (CN) 201400775113

(51) Int. Cl. H02J 7/00

(52) U.S. Cl. CPC H02J 7/0052

(57) ABSTRACT

The present disclosure presents a portable power supply, which comprising an input interface, a charging and discharging control circuit, a microprocessor, a battery and an output interface. The input interface is coupled to the charging and discharging control circuit, the microprocessor, respectively. The input interface is configured to be supplied power by an external power source and transmit the power to both the charging and discharging control circuit and the microprocessor. The charging and discharging control circuit is coupled to the microprocessor, the battery and the output interface, respectively. The charging and discharging control circuit is configured to choose the charging control mode or the discharging control mode according to the charging control signal or the discharging control signal from the microprocessor, for controlling the battery to be charged or to discharge.

### RELATED APPLICATIONS

This application claims priority to Chinese Application No. 2014100775113, filed on Mar. 4, 2014, which is hereby incorporated by reference in its entirety.

### FIELD OF THE INVENTION

The present disclosure relates to a field of power device, more particularly relates to a portable power supply.

### BACKGROUND OF THE INVENTION

Portable power supply is a portable charger with power supply and charging function. The portable power supply can supply power to other electric devices, such as mobile phones, digital cameras and the like. To avoid the low battery of the electric devices, people need to carry a portable power supply while going out. Therefore, how to reduce the volume of the portable power supply is becoming a problem that we need to solve. The circuit structure of the conventional portable power supply is so complicated that it is not conducive to realize the miniaturization of the portable power supply.

### SUMMARY OF THE INVENTION

According to this, the present disclosure is directed to a portable power supply whose circuit structure is simple that can solve the question mentioned above.

A portable power supply includes an input interface, a charging and discharging control circuit, a microprocessor, a battery and an output interface; wherein

the input interface is respectively coupled to the charging and discharging control circuit, the microprocessor, and is configured to be supplied power by an external power source and transmit the power to both the charging and discharging control circuit and the microprocessor;

the charging and discharging control circuit is respectively coupled to the microprocessor, the battery and the output interface, and is configured to choose a charging control mode or a discharging control mode according to a charging control signal or a discharging control signal from the microprocessor for controlling the battery to be charged or to discharge correspondingly;

the microprocessor generates the charging control signal and sends it to the charging and discharging control circuit when the input interface is supplied power by an external power source; the charging and discharging control circuit switches to the charging control mode and supplies power to the battery when the charging and discharging control circuit receives the charging control signal;

the microprocessor is further configured to detect a discharging control instruction, then to convert the discharging control instruction into the discharging control signal, and to send the discharging control signal to the charging and discharging control circuit; the charging and discharging control circuit switches to the discharging control mode and boosts the voltage of the battery to supply power to an electric device that connected to the output interface, when the charging and discharging control circuit receives the discharging control signal.

In one embodiment, the charging and discharging control circuit adopts a pulse width modulation method to reduce voltage in a charging process or to boost voltage in a discharging process.

In one embodiment, the discharging control instruction is one of the instructions including a button control instruction, a shaking control instruction and a touch control instruction.

In one embodiment, the charging and discharging control circuit includes an integrated chip U1, an inductor L1, a PMOSFET Q1, an NMOSFET Q2, resistors R1˜R8 and capacitors C2˜C9,

the source end of the PMOSFET Q1 is connected to the 1st pin of an input interface J1, while the drain end of the PMOSFET Q1 is connected to a power input pin VBUS of the integrated chip U1 and the gate end of the PMOSFET Q1 is connected to the drain end of the NMOSFET Q2; the resistor R2 is connected in parallel between the gate end and the drain end of the PMOSFET Q1, and the drain end of the PMOSFET Q1 is also connected to the capacitor C2 in series and then grounded; the gate end of the NMOSFET Q2 is firstly connected to a resistor R1 in series, and then connected to the microprocessor; the gate end of the NMOSFET Q2 is firstly connected to the resistor R3 in series and then connected to the source end of the NMOSFET Q2 and grounded; data pins D+, D− of the integrated chip U1 are respectively connected to a 2nd pin, a 3rd pin of the input interface J1; a power supply of the low end of a MOSFET input pin REGN of the integrated chip U1 is connected to the resistor R4 and the resistor R5 in series and grounded; the power supply of the low end of a MOSFET input pin REGN is also connected to the capacitor C3 in series and grounded; the first temperature detecting signal input pin TS1 and second temperature detecting signal input pin TS2 of the integrated chip U1 are connected together and then connected to the resistor R6 in series and then grounded; the resistor R6 is connected to the resistor R5 in parallel; a power output pin PMID of the integrated chip U1 is connected to an anode of the capacitor C4, an anode of the capacitor C5 and a 1st pin of the output interface J2, respectively; a cathode of the capacitor C4 and a cathode of the capacitor C5 are connected together and then grounded; one end of the inductor L1 is connected to one end of the capacitor C6, a first switch pin SW1 and a second switch pin SW2 of the integrated chip U1, respectively; the other end of the inductor L1 is connected to an anode of the capacitor C7, an anode of the capacitor C8, a first system control pin SYS1 and a second system control pin SYS2 of the integrated chip U1, respectively; a cathode of the capacitor C7 and a cathode of the capacitor C8 are connected together and then grounded; the other end of the capacitor C6 is connected to a power supply of the high end of a MOSFET input pin BTST; a power pin BAT of the integrated chip U1 is connected to the positive pole P+ of the battery, which is also connected to the capacitor C9 and grounded; a current limited pin ILIM of the integrated chip U1 is connected to the resistor R7 in series and then connected to a grounded pin PGND and grounded; an enable pin C̅E̅ of the integrated chip U1 is connected to the resistor R8 and grounded.

In one embodiment, the microprocessor is an integrated chip U2, and the model of the integrated chip is STM8S103F3,

a PD4 pin, a PA1 pin and a PA2 pin of the integrated chip U2 are connected to an OTG pin, a charging status indicating pin STAT and an external interruption input pin INT of the integrated chip U1, respectively; a PD6 pin of the integrated chip U2 is connected to the collector end of the NPN BJT Q3; the base end of the NPN BJT Q3 is connected to the 1st pin of the output interface J2, while the emitter end of the NPN BJT Q3 is grounded; a resistor R29 is connected in parallel between the base end and the emitter end of the NPN BJT Q3; a grounded pin VSS of the integrated chip U2 is connected to the ground, while a decoupling capacitor C15 is connected in series between the grounded pin VSS and a power supply output pin VCAP; a power pin VDD of the integrated chip U2 is connected to the positive pole P+ of the battery, while a capacitor C16 is connected in series between the power pin VDD and the grounded pin VSS; a control pin PD3 of the integrated chip U2 is connected to one end of the resistor R1, and then connected to the gate end of the NMOSFET Q2 via the resistor R1; a PC7 pin of the integrated chip U2 is connected to a button S1 and then grounded; the button S1 is connected to a capacitor C17 in parallel; a PB4 pin of the integrated chip U2 is firstly connected to a resistor R30 and a resistor R32 and then connected to the positive pole P+ of the battery; a PB5 pin of the integrated chip U2 is firstly connected to a resistor R31 and a resistor R33 and then connected to the positive pole P+ of the battery.

In one embodiment, the portable power supply further includes a lighting circuit, which is respectively coupled to the microprocessor and the battery, and is configured to provide lighting function according to a lighting control signal of the microprocessor;

the lighting circuit comprises resistors R34 and R35, a light emitting diode LED5 and an NPN BJT Q5; one end of the resistor R34 is connected to the positive pole P+ of the battery, while the other end of the resistor R34 is connected to an anode of the light emitting diode LED5; a cathode of the light emitting diode LED5 is connected to the collector end of the NPN BJT Q5; the base end of the NPN BJT Q5 is connected to the resistor R35 in series and then connected to the PD5 pin of the integrated chip U2, while the emitter end of the NPN BJT Q5 is grounded.

In one embodiment, the portable power supply further includes a current sensing circuit, which is coupled to the microprocessor, the charging and discharging control circuit and the output interface, respectively; the current sensing circuit comprises a PNP BJT Q4, resistors R17˜R22, capacitors C12˜C14 and a comparison amplifier U4;

the emitter end of the PNP BJT Q4 is connected to the power supply output pin VCAP of the integrated chip U2; the base end of the PNP BJT Q4 is connected to a resistor R27 in series and then connected to the PD3 pin of the integrated chip U2; the collector end of the PNP BJT Q4 is connected to the resistor R17 and the resistor R21 in series, and then connected to the output terminal of the comparison amplifier U4; a non-inverting input terminal of the comparison amplifier U4 is connected to one end of the resistor R19, one end of the capacitor C14, respectively; the other end of the resistor R19 is connected to the 4th pin of the output interface; the 4th pin of the output interface is connected to a resistor R16 and then grounded; the other end of the capacitor C14 is connected to the capacitor C12 in series and then connected to the output terminal of the comparison amplifier U4; an inverting terminal of the comparison amplifier U4 is connected to the resistor R18 in series and grounded; a 5th pin of the comparison amplifier U4 is connected to one end of the resistor R20 and the capacitor C13, the other end of the capacitor C13 is grounded, while the other end of the resistor R20 is connected to the first system control pin SYS1 and the second system control pin SYS2 of the integrated chip U1; the output terminal of the comparison amplifier U4 is connected to the resistor R22 in series and then connected to a PD2 pin of the integrated chip U2.

In one embodiment, the portable power supply further includes a programming and debugging interface, which is coupled to the microprocessor and is configured to do the online programming and debugging according to demand.

In one embodiment, the portable power supply further includes a display circuit, which is coupled to the microprocessor and is configured to display the battery power according to the control instruction from the microprocessor.

In one embodiment, the portable power supply further includes a protection circuit, which is coupled to the battery and is configured to protect the battery from over-charging, over-discharging, over-current and short circuit.

The charging and discharging control circuit of the portable power supply is configured to choose the charging control mode or the discharging control mode according to the charging control signal or the discharging control signal from the microprocessor, for controlling the battery to be charged or to discharge. When the input interface is supplied power by an external power source that connected to it, the microprocessor generates a charging control signal and sends it to the charging and discharging control circuit and the charging and discharging control circuit switches to the charging control mode. When the microprocessor receives a discharging control instruction, the microprocessor converts the discharging control instruction into a discharging control signal and sends it to the charging and discharging control circuit, the charging and discharging control circuit switches to the discharging control mode thereby. The charging and discharging control circuit can control the battery to be charged or to discharge, so there is no need to set a charging circuit and a discharging circuit respectively. The circuit structure of the portable power supply is so simple that it is conductive to realize the miniaturization of the portable power supply.

### BRIEF DESCRIPTION OF THE DRAWINGS

FIG. 1 is a schematic diagram of an embodiment of a portable power supply;

FIG. 2 is a schematic diagram of another embodiment for the portable power supply;

FIG. 3 is a circuit diagram of the portable power supply of the FIG. 2.

### DETAILED DESCRIPTION OF THE EMBODIMENTS

In order to make the purpose, technical solutions and advantages of the present disclosure be understood more clearly, the present disclosure will be described in further details with the accompanying drawings and the following embodiments. It should be understood that the specific embodiments described herein are merely examples to illustrate the invention, not to limit the present disclosure.

Please refer to the FIG. 1 that is a schematic diagram of an embodiment of a portable power supply. The portable power supply can be charged by an external power source and supply power to electric devices which are connected to it and needed to be charged. Referring to FIG. 1, the embodiment of a portable power supply includes an input interface 110, a charging and discharging control circuit 120, a microprocessor 130, a battery 140, and an output interface 150.

The input interface 110 is coupled to the charging and discharging control circuit 120 and the microprocessor 130, respectively, and is configured to be supplied power by an external power source and transmit the power to both the charging and discharging control circuit 120 and the microprocessor 130. In the illustrated embodiment, the external power source may be a power device with an USB interface, or a power adapter. In the illustrated embodiment, the input interface 110 is a Micro-USB interface. In the other embodiment, the input interface 110 may be a standard USB interface, or includes a standard USB interface and a Micro-USB interface. In the illustrated embodiment, the voltage input through the input interface 110 is 5V.

The charging and discharging control circuit is also coupled to the microprocessor 130, the battery 140 and the output interface 150, respectively. The charging and discharging control circuit 120 is configured to choose a charging control mode or a discharging control mode according to a charging control signal or a discharging control signal from the microprocessor 130, so as to control the battery 140 to be charged or to discharge. Specifically, the charging and discharging control circuit 120 mainly includes an integrated chip and an inductance element. In the illustrated embodiment, the charging and discharging control circuit 120 adopts a pulse width modulation method to reduce voltage in a charging process or to boost voltage in a discharging process. The charging current and the discharging current are increased since using the pulse width modulation method, therefore the time of both charging and discharging are greatly reduced. What's more, the transfer efficiency is improved by using the pulse width modulation method, and the portable power supply is also in low heating value.

The microprocessor 130 is coupled to the input interface 110, the charging and discharging control circuit 120, respectively, and is configured to achieve the overall control of the portable power supply. When the input interface 110 is supplied power by an external power source that connected to it, the microprocessor 130 generates a charging control signal to the charging and discharging control circuit 120. When the charging and discharging control circuit 120 receives the charging control signal, it switches to the charging control mode and reduces the voltage of the external power source via an inductance element by using the pulse width modulation method and then charges the battery 140. In the illustrated embodiment, the charging and discharging control circuit 120 converts the 5V voltage to a 4.3V voltage for charging the battery 140 with constant current and constant voltage.

The microprocessor 130 is further configured to receive a discharging control instruction, then to convert the charging control instruction into a discharging control signal correspondingly, and to send it to the charging and discharging control circuit 120. When the charging and discharging control circuit 120 receives the discharging control signal, it switches to the discharging control mode and boosts the voltage of the battery via the inductance element by using the pulse width modulation method and then transmits it to the output interface 150. Wherein, the discharging control instruction is a kind of instruction that controlling the portable power supply to discharge. Specifically, the discharging control instruction may be a button control instruction, a shaking control instruction or a touch control instruction. In the illustrated embodiment, the microprocessor 130 is connected to a button, thus users can press down the button to send a discharging control instruction.

The output interface 150 is configured to connect an electric device which is needed to be charged. In the illustrated embodiment, the electric device may be a digital product, such as mobile phone, MP3, MP4, PDA, video games console, digital camera, repeater, digital video and the like. In the illustrated embodiment, the output interface 150 is a standard USB interface. The portable power supply may have more than one output interface 150 which make it can supply power to a plurality of electric devices at the same time.

The microprocessor 130 of the portable power supply can choose the working mode of the charging and discharging control circuit 120, so as to achieve the charging control or the discharging control of the battery 140. The circuit structure of the portable power supply is so simple that there is no need to set a charging circuit and a discharging circuit, respectively, which is conductive to realize the miniaturization of the portable power supply. Meanwhile, the process of both charging and discharging use a same integrated chip and a same inductance element, which is conductive to reduce the cost of the products. What's more, the charging and discharging control circuit 120 adopts the pulse width modulation method to adjust the voltage in the process of both charging and discharging, which makes the charging current and the discharging current increased, and consequently it reduces the time of both charging and discharging.

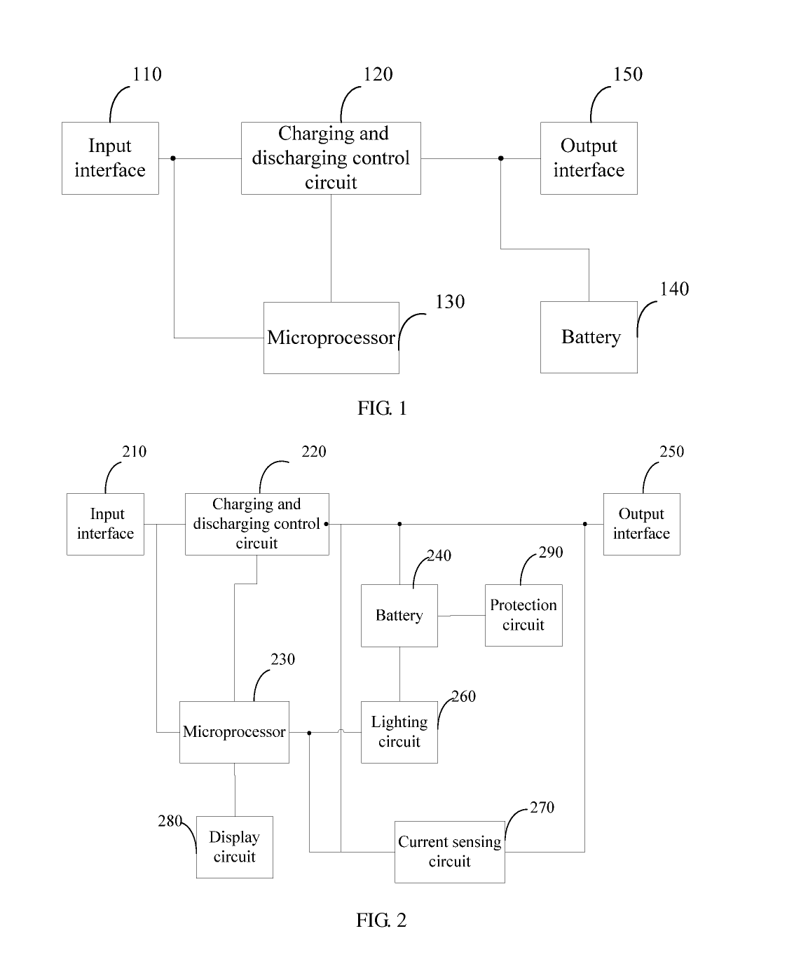

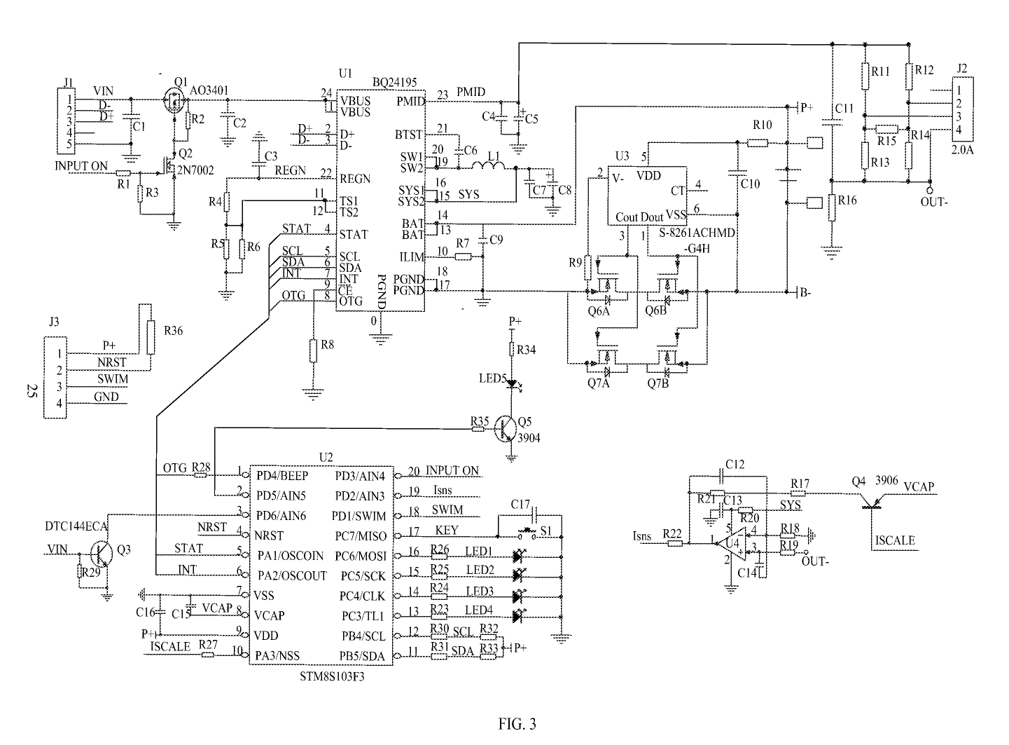

Please refer to the FIG. 2 that is a schematic diagram of another embodiment for the portable power supply. In the illustrated embodiment, the portable power supply includes an input interface 210, a charging and discharging control circuit 220, a microprocessor 230, a battery 240 and an output interface 250, and it further includes a lighting circuit 260, a current sensing circuit 270, a display circuit 280 and a protection circuit 290.

The lighting circuit 260 is coupled to the battery 240 and the microprocessor 230, respectively, and it is configured to provide lighting function according to a lighting control signal from the microprocessor 230. The lighting circuit 260 mainly includes a light emitting diode. Specifically, the microprocessor 230 is also configured to receive a lighting control instruction, and to convert it into a lighting control signal which is sent to the lighting circuit. Wherein, the lighting control instruction is a kind of instruction that controlling the portable power supply to switch to a lighting status. In detailed, the lighting control instruction may be a button control instruction, a shaking control instruction or a touch control instruction. In the illustrated embodiment, the microprocessor 230 is connected to a button, thus the user can press down the button for sending a lighting control instruction. The times of the button-presses and the button-holding time can be used to distinguish clearly between the lighting control instruction and the discharging control instruction. In the illustrated embodiment, pressing the button once represents the discharging control instruction while pressing the button twice continuously represents the lighting control instruction.

The current sensing circuit 270 is coupled to the output interface 250, the microprocessor 230 and the charging and discharging control circuit 220, respectively. The current sensing circuit 270 is configured to detect the output current in the discharging process and compare it with a reference current value, then feed back the consequence to the microprocessor 230. The microprocessor 230 judges whether the over-current occurs in the discharging process and whether there is any electric devices connected according to the feedback current information from the current sensing circuit 270, and then make a corresponding operation. When the microprocessor 230 determines that the portable power supply is in an over-current status in the discharging process, it controls the charging and discharging control circuit 220 to stop discharging. When the microprocessor 230 determines that there is no electric device connected to the output interface 250, it controls the charging and discharging control circuit 220 to stop discharging and to switch to a sleep status.

The display circuit 280 is coupled to the microprocessor 230, and is configured to display a battery power according to the control instruction from the microprocessor 230. In the illustrated embodiment, the display circuit 280 displays the battery power via a plurality of light emitting diodes. In other embodiment, the display circuit 280 may be a LCD display monitor or a LED display monitor. The display monitor can accurately display the level of the battery 240, and display the available time of the remaining battery power at the same time, so that people can efficiently plan the use of the battery power of the portable power supply and the electric device. In the illustrated embodiment, the user can send an instruction of inquiring about the battery power via a button connected to the microprocessor 230. When the microprocessor 230 receives the instruction of inquiring about the battery power, the microprocessor 230 detects the battery power and controls the display circuit 280 to display it. In the illustrated embodiment, the display circuit 280 includes four white light emitting diodes, which displays the power of battery 240 by the number of the lighted light emitting diodes. The microprocessor 230 also controls the display circuit 280 to display the power of battery 240 while the charging and discharging control circuit 220 is working. The user can judge the power status of the battery 240 according to what the display circuit 280 displayed.

The protection circuit 290 is couple to the positive pole and the negative pole of the battery 240, and the negative pole of the battery 240 is grounded via the protection circuit 290. The protection circuit 290 is configured to protect the battery 240 from over-charging, over-discharging and short circuit, so that it can prevent the battery from a damage when the charging and discharging control are abnormal.

In the illustrated embodiment, the portable power supply further includes a programming and debugging interface. The programming and debugging interface is coupled to the microprocessor 230, and is configured to do the online programming and debugging according to demand.

Please refer to the FIG. 3 that is a circuit diagram of the portable power supply of the FIG. 2. In the illustrated embodiment, the charging and discharging control circuit mainly includes an integrated chip U1, while the microprocessor is an integrated chip U2.

As shown in the figure, the charging and discharging control circuit 220 includes the integrated chip U1, an inductor L1, a PMOSFET Q1, an NMOSFET Q2, resistors R1˜R8 and capacitors C2˜C9. In detailed, the source end of the PMOSFET Q1 is connected to the 1st pin (namely a power pin VIN) of an input interface J1, while the drain end of the PMOSFET Q1 is connected to a power input pin VBUS of the integrated chip U1, and the gate end of the PMOSFET Q1 is connected to the drain end of the NMOSFET Q2. Wherein, the resistor R2 is connected in parallel between the gate end and the drain end of the PMOSFET Q1, and the drain end of the PMOSFET Q1 is also connected to the capacitor C2 in series and then grounded. The gate end of the NMOSFET Q2 is firstly connected to a resistor R1 in series, and then connected to a control pin PD3 of the integrated chip U2. The gate end of the NMOSFET Q2 is firstly connected to the resistor R3 in series and then connected to the source end of the NMOSFET Q2 and grounded. Data pins D+, D− of the integrated chip U1 are connected to a 2nd pin, a 3rd pin of the input interface J1, respectively. A power supply of the low end of a MOSFET input pin REGN of the integrated chip U1 is connected to the resistor R4 and the resistor R5 in series and grounded. Wherein, the power supply of the low end of a MOSFET input pin REGN is also connected to the capacitor C3 in series and grounded. The first temperature detecting signal input pin TS1 and the second temperature detecting signal input pin TS2 of the integrated chip U1 are connected together and then connected to the resistor R6 in series and grounded. Wherein, the resistor R6 is connected to the resistor R5 in parallel. In other embodiment, the resistor R5 may be a negative temperature coefficient thermistor. A power output pin PMID of the integrated chip U1 is connected to an anode of the capacitor C4, an anode of the capacitor C5 and the 1st pin of the output interface J2, respectively. Wherein, a cathode of the capacitor C4 and a cathode of the capacitor C5 are connected together and then grounded. One end of the inductor L1 is connected to one end of the capacitor C6, a first switch pin SW1 and a second switch pin SW2 of the integrated chip U1, respectively. The other end of the inductor L1 is connected to an anode of the capacitor C7, an anode of the capacitor C8, a first system control pin SYS1 and a second system control pin SYS2 of the integrated chip U1, respectively. Wherein a cathode of the capacitor C7 and a cathode of the capacitor C8 are connected together and then grounded. The other end of the capacitor C6 is connected to a power supply of the high end of a MOSFET input pin BTST. A power pin BAT of the integrated chip U1 is connected to the positive pole P+ of the battery, which is also connected to the capacitor C9 and grounded. A current limited pin ILIM of the integrated chip U1 is connected to the resistor R7 in series and then connected to a grounded pin PGND and grounded. Wherein, the grounded pin PGND is also connected to the source end of the MOSFET in the protection circuit. An enable pin C̅E̅ of the integrated chip U1 is connected to the resistor R8 and then grounded. In the illustrated embodiment, the model of the integrated chip U1 may be BQ24195, while the model of the integrated chip U2 may be STM8S103F3. The model of the PMOSFET Q1 may be A03401, while the model of the NMOSFET Q2 may be 2N7002.

A PD4 pin, a PA1 pin and a PA2 pin of the integrated chip U2 are connected to an OTG pin, a charging status indicating pin STAT and an external interruption input pin INT of the integrated chip U1, respectively. A PD6 pin of the integrated chip U2 is connected to the collector end of the NPN BJT Q3. The base end of the NPN BJT Q3 is connected to the 1st pin of the output interface J2, while the emitter end of the NPN BJT Q3 is grounded. A resistor R29 is connected in parallel between the base end and the emitter end of the NPN BJT Q3. A grounded pin VSS of the integrated chip U2 is connected to the ground, while a decoupling capacitor C15 is connected in series between the grounded pin VSS and a power supply output pin VCAP. A power pin VDD of the integrated chip U2 is connected to the positive pole P+ of the battery, while a capacitor C16 is connected in series between the power pin VDD and the grounded pin VSS. A control pin PD3 of the integrated chip U2 is connected to one end of the resistor R1, and connected to the gate end of the NMOSFET Q2 via the resistor R1. A PC7 pin of the integrated chip U2 is connected to a button S1 and then grounded. Wherein, the button S1 is connected to a capacitor C17 in parallel. A PB4 pin of the integrated chip U2 is firstly connected to a resistor R30 and a resistor R32 and then connected to the positive pole P+ of the battery. A PB5 pin of the integrated chip U2 is firstly connected to a resistor R31 and a resistor R33 and then connected to the positive pole P+ of the battery.

In detailed, when there is a 5V voltage input through the input interface J1, the NPN BJT Q3 is turned on under the control of the 5V voltage, and the PD6 pin of the integrated chip U2 is converted from the original high level into a low level, which further control the PD3 pin to be converted into a high level from the original low level. The NMOSFET Q2 is turned on under the control of the integrated chip U2, which further control the PMOSFET Q1 to be turned on, so the integrated chip U1 is power-on. The integrated chip U2 establishes communication with the integrated chip U1 through the PD4 pin, the PA1 pin and the PA2 pin, so that it can send a charging control signal to the integrated chip U1. When the integrated chip U1 receives the charging control signal, it switches to the charging control mode, and reduces voltage via the inductor L1 by using the pulse width modulation method, for charging the battery with constant current and constant voltage. When the battery is fully charged, the integrated chip U2 controls both the PMOSFET Q1 and the NMOSFET Q2 to be turned off, so the integrated chip U1 stops working. When there is an electric device connected to the output interface J2, the user sends a discharging control instruction by pressing down the button. When the integrated chip U2 receives the discharging control instruction, it converts the discharging control instruction into a discharging control signal correspondingly and sends it to the integrated chip U1. The integrated chip U1 switches to the discharging control mode and boosts the voltage of the battery for providing power to outside when it receives the discharging control signal.

In the illustrated embodiment, the lighting circuit includes a current limiting resistor R34 and R35, a light emitting diode LED5 and an NPN BJT Q5. One end of the resistor R34 is connected to the positive pole P+ of the battery, while the other end of the resistor R34 is connected to an anode of the light emitting diode LED5. A cathode of the light emitting diode LED5 is connected to the collector end of the NPN BJT Q5. The base end of the NPN BJT Q5 is connected to the resistor R35 in series and then connected to the PD5 pin of the integrated chip U2, while the emitter end of the NPN BJT Q5 is grounded. When the user need to use the lighting function, they can press down the button S1 to send a lighting control instruction. The integrated chip U2 converts the lighting control instruction received into a lighting control signal and sends it to the lighting circuit, so that the lighting circuit starts to work. In the illustrated embodiment, pressing the button S1 twice continuously represents the lighting control instruction. When the integrated chip U2 receives the lighting control instruction, it set the PD5 pin into high level, which controls the NPN BJT Q5 turned on and the lighting circuit into working status.

In the illustrated embodiment, the current sensing circuit includes a PNP BJT Q4, resistors R17˜R22, capacitors C12˜C14 and a comparison amplifier U4. The emitter end of the PNP BJT Q4 is connected to the power supply output pin VCAP of the integrated chip U2. The base end of the PNP BJT Q4 is connected to the resistor R27 in series and then connected to the PA3 pin of the integrated chip U2. The collector end of the PNP BJT Q4 is connected to the resistor R17 and the resistor R21 in series, and then connected to the output terminal of the comparison amplifier U4. A non-inverting input terminal of the comparison amplifier U4 is respectively connected to one end of the resistor R19, one end of the capacitor C14. Wherein the other end of the resistor R19 is connected to the 4th pin of the output interface J2. The 4th pin of the output interface J2 is connected to a resistor R16 and then grounded. The other end of the capacitor C14 is connected to the capacitor C12 in series and then connected to the output terminal of the comparison amplifier U4. An inverting terminal of the comparison amplifier U4 is connected to the resistor R18 in series and grounded. A 5th pin of the comparison amplifier U4 is connected to one end of the resistor R20 and the capacitor C13. Wherein, the other end of the capacitor C13 is grounded, while the other end of the resistor R20 is connected to the first system control pin SYS1 and the second system control pin SYS2 of the integrated chip U1. The output terminal of the comparison amplifier U4 is connected to the resistor R22 in series and then connected to the PD2 pin of the integrated chip U2.

There is the working principle of the current sensing circuit as follows.

In the discharging process, the current sensing circuit detects the output current and sends it to the non-inverting terminal of the comparison amplifier U4. The comparison amplifier U4 compares the output current with a reference current. When the output current is higher than the reference current, the output terminal of the comparison amplifier U4 outputs a high level to the integrated chip U2. When the integrated chip U2 detected the level signal, it controls the integrated chip U1 to stop outputting the 5V voltage. In the illustrated embodiment, the reference current is set to be 2.2˜2.5V. When there is no electric device connected to the output interface J2, the comparison amplifier U4 works as an amplifier, which amplifies the output current and outputs it through the output terminal. When the output current of the comparison amplifier U4 is less than the current value (60±30 mA) set by the integrated chip U2, the integrated chip U2 controls the integrated chip U1 to stop outputting the 5V voltage, and controls the portable power supply to switch to a sleep status.

The portable power supply further includes a programming and debugging interface J3, which is configured to do the online programming and debugging to the integrated chip U2. In detailed, a 1st pin of the programming and debugging interface J3 is connected to the positive pole P+ of the battery, while a 2nd pin, a 3rd pin are connected to a single wire interface module pin SWIM, an external reset pin NRST, respectively. Wherein a resistor R36 is connected between the 1st pin and the 2nd pin of the programming and debugging interface J3, while a 4th pin is grounded. The programming and debugging interface J3 can do the online programming and debugging for the integrated chip U2, which is conductive to realize the multi-function of the portable power supply.

In the illustrated embodiment, the display circuit has a plurality of light emitting diodes, and is configured to display the battery power. In detailed, the display circuit includes four light emitting diodes. An anode of the light emitting diode LED1, LED2, LED3 and LED4 are connected to a current limiting resistor R26, R25, R24 and R23, and then connected to a PC6 pin, PC5 pin, PC4 pin and PC6 pin of the integrated chip U2, respectively. A cathode of the light emitting diode LED1, LED2, LED3 and LED4 are grounded. Wherein, the light emitting diode is a white light emitting diode. The display circuit displays the battery power through the number of the lighted light emitting diodes.

In the illustrated embodiment, the protection circuit of the portable power supply mainly includes a protection IC U3 and a MOSFET Q6 and Q7. The protection circuit controls the conduction condition of the MOSFET Q6 and Q7 by the protection IC U3 for protecting the battery from over-charging, over-discharging, over-current and short circuit, so that it can prevent the battery from a damage when the charging and discharging control are abnormal.

The foregoing examples are preferred embodiments of the present invention only and not intended to limit the present disclosure. It should be understood that, to the person skilled in the art, various modifications and improvements can be made without departing from the spirit and principle of the present disclosure, which should all be included within the scope of the present disclosure. Therefore, the protection scope of the present disclosure shall be defined by the appended claims.

What is claimed is:

1. A portable power supply, comprising an input interface, a charging and discharging control circuit, a microprocessor, a battery and an output interface; wherein
the input interface is respectively coupled to the charging and discharging control circuit, the microprocessor, and is configured to be supplied power by an external power source and transmit the power to both the charging and discharging control circuit and the microprocessor;
the charging and discharging control circuit is respectively coupled to the microprocessor, the battery and the output interface, and is configured to choose a charging control mode or a discharging control mode according to a charging control signal or a discharging control signal from the microprocessor for controlling the battery to be charged or to discharge correspondingly;
the microprocessor generates the charging control signal and sends it to the charging and discharging control circuit when the input interface is supplied power by an external power source; the charging and discharging control circuit switches to the charging control mode and supplies power to the battery when the charging and discharging control circuit receives the charging control signal;
the microprocessor is further configured to detect a discharging control instruction, then to convert the discharging control instruction into the discharging control signal, and to send the discharging control signal to the charging and discharging control circuit; the charging and discharging control circuit switches to the discharging control mode and boosts the voltage of the battery to supply power to an electric device that connected to the output interface, when the charging and discharging control circuit receives the discharging control signal.

2. The portable power supply according to claim 1, wherein the charging and discharging control circuit adopts a pulse width modulation method to reduce voltage in a charging process or to boost voltage in a discharging process.

3. The portable power supply according to claim 1, wherein the discharging control instruction is one of the instructions including a button control instruction, a shaking control instruction and a touch control instruction.

4. The portable power supply according to claim 1, wherein the charging and discharging control circuit comprises an integrated chip U1, an inductor L1, a PMOSFET Q1, an NMOSFET Q2, resistors R1˜R8 and capacitors C2˜C9,
the source end of the PMOSFET Q1 is connected to the 1st pin of an input interface J1, while the drain end of the PMOSFET Q1 is connected to a power input pin VBUS of the integrated chip U1 and the gate end of the PMOSFET Q1 is connected to the drain end of the NMOSFET Q2; the resistor R2 is connected in parallel between the gate end and the drain end of the PMOSFET Q1, and the drain end of the PMOSFET Q1 is also connected to the capacitor C2 in series and then grounded; the gate end of the NMOSFET Q2 is firstly connected to a resistor R1 in series, and then connected to the microprocessor; the gate end of the NMOSFET Q2 is firstly connected to the resistor R3 in series and then connected to the source end of the NMOSFET Q2 and grounded; data pins D+, D− of the integrated chip U1 are respectively connected to a 2nd pin, a 3rd pin of the input interface J1; a power supply of the low end of a MOSFET input pin REGN of the integrated chip U1 is connected to the resistor R4 and the resistor R5 in series and grounded; the power supply of the low end of a MOSFET input pin REGN is also connected to the capacitor C3 in series and grounded; the first temperature detecting signal input pin TS1 and second temperature detecting signal input pin TS2 of the integrated chip U1 are connected together and then connected to the resistor R6 in series and then grounded; the resistor R6 is connected to the resistor R5 in parallel; a power output pin PMID of the integrated chip U1 is connected to an anode of the capacitor C4, an anode of the capacitor C5 and a 1st pin of the output interface J2, respectively; a cathode of the capacitor C4 and a cathode of the capacitor C5 are connected together and then grounded; one end of the inductor L1 is connected to one end of the capacitor C6, a first switch pin SW1 and a second switch pin SW2 of the integrated chip U1, respectively; the other end of the inductor L1 is connected to an anode of the capacitor C7, an anode of the capacitor C8, a first system control pin SYS1 and a second system control pin SYS2 of the integrated chip U1, respectively; a cathode of the capacitor C7 and a cathode of the capacitor C8 are connected together and then grounded; the other end of the capacitor C6 is connected to a power supply of the high end of a MOSFET input pin BTST; a power pin BAT of the integrated chip U1 is connected to the positive pole P+ of the battery, which is also connected to the capacitor C9 and grounded; a current limited pin ILIM of the integrated chip U1 is connected to the resistor R7 in series and then connected to a grounded pin PGND and grounded; an enable pin C̅E̅ of the integrated chip U1 is connected to the resistor R8 and grounded.

5. The portable power supply according to claim 4, wherein the microprocessor is an integrated chip U2, and the model of the integrated chip is STM8S103F3,
a PD4 pin, a PA1 pin and a PA2 pin of the integrated chip U2 are connected to an OTG pin, a charging status indicating pin STAT and an external interruption input pin INT of the integrated chip U1, respectively; a PD6 pin of the integrated chip U2 is connected to the collector end of the NPN BJT Q3; the base end of the NPN BJT Q3 is connected to the 1st pin of the output interface J2, while the emitter end of the NPN BJT Q3 is grounded; a resistor R29 is connected in parallel between the base end and the emitter end of the NPN BJT Q3; a grounded pin VSS of the integrated chip U2 is connected to the ground, while a decoupling capacitor C15 is connected in series between the grounded pin VSS and a power supply output pin VCAP; a power pin VDD of the integrated chip U2 is connected to the positive pole P+ of the battery, while a capacitor C16 is connected in series between the power pin VDD and the grounded pin VSS; a control pin PD3 of the integrated chip U2 is connected to one end of the resistor R1, and then connected to the gate end of the NMOSFET Q2 via the resistor R1; a PC7 pin of the integrated chip U2 is connected to a button S1 and then grounded; the button S1 is connected to a capacitor C17 in parallel; a PB4 pin of the integrated chip U2 is firstly connected to a resistor R30 and a resistor R32 and then connected to the positive pole P+ of the battery; a PB5 pin of the integrated chip U2 is firstly connected to a resistor R31 and a resistor R33 and then connected to the positive pole P+ of the battery.

6. The portable power supply according to claim 5, further comprising a lighting circuit, which is respectively coupled to the microprocessor and the battery, and is configured to provide lighting function according to a lighting control signal of the microprocessor;
the lighting circuit comprises resistors R34 and R35, a light emitting diode LED5 and an NPN BJT Q5; one end of the resistor R34 is connected to the positive pole P+ of the battery, while the other end of the resistor R34 is connected to an anode of the light emitting diode LED5; a cathode of the light emitting diode LED5 is connected to the collector end of the NPN BJT Q5; the base end of the NPN BJT Q5 is connected to the resistor R35 in series and then connected to the PD5 pin of the integrated chip U2, while the emitter end of the NPN BJT Q5 is grounded.

7. The portable power supply according to claim 5, further comprising a current sensing circuit, which is coupled to the microprocessor, the charging and discharging control circuit and the output interface, respectively; the current sensing circuit comprises a PNP BJT Q4, resistors R17˜R22, capacitors C12˜C14 and a comparison amplifier U4;
the emitter end of the PNP BJT Q4 is connected to the power supply output pin VCAP of the integrated chip U2; the base end of the PNP BJT Q4 is connected to a resistor R27 in series and then connected to the PD3 pin of the integrated chip U2; the collector end of the PNP BJT Q4 is connected to the resistor R17 and the resistor R21 in series, and then connected to the output terminal of the comparison amplifier U4; a non-inverting input terminal of the comparison amplifier U4 is connected to one end of the resistor R19, one end of the capacitor C14, respectively; the other end of the resistor R19 is connected to the 4th pin of the output interface; the 4th pin of the output interface is connected to a resistor R16 and then grounded; the other end of the capacitor C14 is connected to the capacitor C12 in series and then connected to the output terminal of the comparison amplifier U4; an inverting terminal of the comparison amplifier U4 is connected to the resistor R18 in series and grounded; a 5th pin of the comparison amplifier U4 is connected to one end of the resistor R20 and the capacitor C13, the other end of the capacitor C13 is grounded, while the other end of the resistor R20 is connected to the first system control pin SYS1 and the second system control pin SYS2 of the integrated chip U1; the output terminal of the comparison amplifier U4 is connected to the resistor R22 in series and then connected to a PD2 pin of the integrated chip U2.

8. The portable power supply according to claim 1, further comprising a programming and debugging interface, which is coupled to the microprocessor and is configured to do the online programming and debugging according to demand.

9. The portable power supply according to claim 1, further comprising a display circuit, which is coupled to the microprocessor and is configured to display the battery power according to the control instruction from the microprocessor.

10. The portable power supply according to claim 1, further comprising a protection circuit, which is coupled to the battery and is configured to protect the battery from over-charging, over-discharging, over-current and short circuit.
